(19) United States
(12) Patent Application Publication
(10) Pub. No.: US 2017/0096110 A1
(43) Pub. Date: Apr. 6, 2017

(54) Bicycle Retaining Device

(71) Applicant: Thule Sweden AB, Hillerstorp (SE)

(72) Inventors: Andreas ARVIDSSON, Sävsjö (SE); Morgan LINDELL, Värnamo (SE); Olof LINDHOLM, Värnamo (SE); Anders NILVIUS, Värnamo (SE)

(21) Appl. No.: 15/311,444

(22) PCT Filed: Apr. 21, 2015
(86) PCT No.: PCT/EP2015/058591

§ 371 Date: Nov. 15, 2016

(30) Foreign Application Priority Data
May 19, 2014 (EP) 14168820.0

(51) Int. Cl. B60R 9/048; B60R 9/06; B60R 9/10

(52) U.S. Cl. CPC B60R 9/048; B60R 9/10; B60R 9/06

(57) ABSTRACT

A bicycle retaining device (1) for retaining a bicycle in a bicycle carrier arrangement on a transporting vehicle. The second claw part (7) is arranged to be movable with respect to the supporting arm (2) and the first claw part (5) such that a distance (d) between the first and the second bicycle abutment surfaces (6,8) is adjustable between a maximum distance (dₘₐₓ) and a minimum distance (dₘᵢₙ). A catch (15) is arranged at the outer end (11) of the first claw part (5) and has a catching position with the catch (15) extending from the outer end (11) of the first claw part (5) in a direction toward the outer end (13) of the second claw part (7). When in the catching position, the catch (15) is arranged to partially bridge the maximum distance (dₘₐₓ) between the first and the second abutment surfaces (6,8).

### TECHNICAL FIELD

The disclosure pertains to a bicycle retaining device for retaining a bicycle in a bicycle carrier arrangement on a transporting vehicle. The bicycle retaining device comprises an elongated supporting arm extending in a longitudinal direction of the retaining device and comprising a retaining claw arranged at an outer end of the supporting arm. The retaining claw is a two-part clamping device comprising a first claw part having a first bicycle abutment surface and a second claw part having a second bicycle abutment surface and being arranged with the second bicycle abutment surface facing the first bicycle abutment surface. The first claw part is rigidly joined to the supporting arm while the second claw part is arranged to be movable with respect to the supporting arm and the first claw part such that a distance between the first and the second bicycle abutment surfaces is adjustable between a maximum distance and a minimum distance

### BACKGROUND

In order to simplify transport of bicycles by means of a vehicle such as a car or a recreational vehicle, different types of bicycle carrier arrangements are provided. The two main types of bicycle carrier arrangements which are available are those adapted for mounting on a vehicle roof and those adapted for mounting at the rear of a vehicle. Roof mounted carrier arrangements usually comprise a rail section which is mounted on a roof rack in the longitudinal direction of the vehicle, i.e. in the travelling direction of the vehicle and various clamps and other fastening devices for securing the bicycle in an upright position with the wheels resting in the rail section. Rear mounted carrier arrangements may include a supporting arm which a bicycle clamping device at one end and may also comprise a rail for supporting the wheels of the bicycle as well as further clamps and fastening devices.

When loading a bicycle onto the previously known bicycle carrier arrangements, a difficulty arises in the initial phase of securing the bicycle to the carrier arrangement when a person performing the loading operation often experiences a need for more than two hands in order to be able to hold the bicycle in place while applying and tightening different securement devices. This may be a particular problem when loading a bicycle onto a carrier arrangement on a vehicle roof, where it may be difficult to reach the bicycle and get a proper hold on it even if two persons are involved in the loading operation.

In order to facilitate loading of a bicycle on a carrier arrangement, it has been suggested in WO03/106221 to provide the carrier arrangement with a bicycle supporting arm which is attached to the carrier arrangement at one end, and which has a claw grip at the opposite free end. The carrier arrangement is further provided with a wheel supporting rail which has an inclined portion in one wheel supporting area of the rail whereby a bicycle loaded onto the rail is caused to roll in the rail until a part of the bicycle frame comes into active engagement with at least one of the jaws of the claw grip.

Although the arrangement in WO03/106221 facilitates loading of a bicycle on the carrier arrangement, it has been found that the stability of the bicycle in the initial loading phase is unsatisfactory and that there is still a risk that the bicycle falls out of the carrier arrangement when manipulating and tightening the securement devices of the carrier arrangement.

Accordingly, there remains a need for an improved bicycle carrier arrangement, and for a retaining device which can stabilise a bicycle in a loading position during an initial loading phase of a bicycle in a bicycle carrier arrangement.

### SUMMARY

It is an object of the present invention to alleviate the stability problems encountered when loading a bicycle into a bicycle carrier arrangement.

This object may be achieved by the subject-matter of claims 1 and 10. Embodiments of the claimed invention are set forth in the appended dependent claims, in the following description, and in the drawings.

As disclosed herein, there is provided a bicycle retaining device for retaining a bicycle in a bicycle carrier arrangement on a transporting vehicle, the bicycle retaining device comprising an elongated supporting arm extending in a longitudinal direction of the retaining device, the retaining device comprising a retaining claw being arranged at an outer end of the supporting arm, the retaining claw comprising a first claw part comprising a first bicycle abutment surface and being connected to the supporting arm, and a second claw part comprising a second bicycle abutment surface, the second claw part being arranged with the second bicycle abutment surface facing the first bicycle abutment surface, the second claw part being arranged to be movable with respect to the first claw part and optionally to the support arm, or said first claw part (5) being arranged to be movable with respect to said second claw part (7), such that a distance between the first and the second bicycle abutment surfaces is adjustable between a maximum distance and a minimum distance. The first claw part has an inner end proximal to the supporting arm and an outer end distal from the supporting arm, and the second claw part has an inner end proximal to the supporting arm and an outer end distal from the supporting arm, wherein a catch is arranged at the outer end of the first claw part, the catch having a catching position with the catch extending from the outer end of the first claw part in a direction toward the outer end of the second claw part, the catch being arranged to partially bridge the maximum distance between the first and the second abutment surfaces.

The second claw part may be positioned outward of the first claw part at the outer end of the supporting arm, implying that the outer claw part is the claw part that is movable for opening and closing the retaining claw while the inner claw part is rigidly joined to the supporting arm.

Alternatively the second, movable claw part may be positioned inward of the first claw part at the outer end of the supporting arm, implying that the inner claw part may be the claw part that is movable for opening and closing the retaining claw while the outer claw part is rigidly joined to the supporting arm.

The first claw part may be rigidly joined to the supporting arm and may be integrally formed with the supporting arm or may be formed as a separate element that has been attached to the supporting arm in a fixed position.

The catch protrudes from the outer end of the first claw part and partially closes the gap between the first claw part and the second claw part of the bicycle retaining device when the retaining claw is in a maximum open position with a maximum distance between the claw parts. When a bicycle frame element is inserted between the first and second claw parts and has been brought into abutment with the first bicycle abutment surface, the catch prevents the bicycle frame element from accidentally moving out from between the claw parts. The only way the bicycle frame element can be disengaged from between the claw parts is by purposeful movement of the bicycle retaining device or the bicycle such that the bicycle frame element comes into alignment with the non-closed part of the gap between the claw parts and can be moved out of the retaining claw.

The claw parts may be made from any suitable material or combination of materials, including polymeric materials, composite materials, and metal. The bicycle abutment surfaces are preferably formed from a softer and preferably compressible material such as natural or synthetic rubber which may act as a shock absorber during use of the bicycle retaining device. Such shock absorbing material may also be applied on the surface of the catch which is facing into the gap between the first and second claw parts. However, it is generally preferred that the catch be mainly made from a rigid and shock resistant material. Accordingly, the catch may be made from the same types of material as the claw parts and may be made as a separate part which is attached to the first claw part or may be made integral with the first claw part, e.g. by molding techniques.

When in the catching position the loading gap, i.e. the non-closed part of the gap between the first and second claw parts in the loading position of the retaining claw should be large enough to allow a bicycle frame element to be comfortably inserted between the claw parts. To this end, the catch may be arranged to bridge at least 25% of the maximum distance between the first and the second abutment surfaces, but not more than 55% of the maximum distance between the first and the second abutment surfaces, such as from 30% to 45% of the maximum distance between the first and the second abutment surfaces.

It is to be understood that the bicycle retaining device may be designed with a loading gap which is adapted to the size of a specific bicycle frame element or may be designed such that it will fit a range of differently sized bicycle frame elements. In the latter case, the bicycle retaining device may be used on differently sized frame elements in different retaining positions on the same bicycle and/or corresponding but differently sized frame elements on different bicycles. Bicycle frame elements may, for instance, have a circular or oval cross-section. The size of a circular bicycle frame element commonly ranges from 22 millimeters to 80 millimeters. An oval bicycle frame element is usually somewhat larger, such as approximately 80×100 millimeters.

In order to accommodate commonly occurring bicycle frame elements, the distance between the first claw part including the catch and the second claw part in the maximum open position of the retaining claw may be in the order of 90 mm-130 mm, as measured from the tip of the catch to the outer end of the second claw part. This distance defines the size of the entrance opening into the retaining claw. The catch may have a height as measured from the first bicycle abutment surface at the outer end of the first claw part of from 25 mm to 50 mm. The height is measured in the longitudinal direction of the bicycle retaining device.

The bicycle abutment surfaces may have a lateral extension of from 60-100 mm, such as from 80-90 mm. The bicycle abutment surfaces may have the same or different lateral extensions, as set out herein.

In a bicycle retaining device as disclosed herein, a lateral extension of the first claw part away from the supporting arm may be greater than a lateral extension of the second claw part away from the supporting arm, whereby the catch being arranged at the outer end of the first claw part is positioned laterally outward of the outer end of the second claw part in a lateral direction of the bicycle retaining device. Accordingly, the first claw part with the catch may be arranged as a protruding jaw with respect to the second claw part. When closing the retaining claw, in particular when the bicycle abutment surfaces of the retaining jaw is at the minimum distance from each other, the catch extends in the longitudinal direction of the bicycle retaining device outward of the outer end of the second claw part. In other words, the extension of the second claw part in the lateral direction is smaller than the distance between the supporting arm and the catch.

The catch may be attached to the first claw part with a hinge and be foldable inward at the hinge towards the first bicycle abutment surface to assume a temporary loading position. Accordingly, the catch may be arranged such that it tilts inward when a bicycle frame element is being inserted between the claw parts, thus temporarily widening the loading gap between the claw parts. The catch is preferably spring biased towards the catching position, such that it automatically returns to the catching position once the bicycle frame element has been moved into the retaining claw.

It is also conceivable that the catch is made retractable, such that it may be moved out of the loading gap by pulling or pushing in the longitudinal direction of the bicycle retaining device. Also in this case, it may be preferred that the catch is spring biased towards the catching position, such that it will automatically return to the catching position once the bicycle frame element has been moved into the retaining claw. The catch may have a slanted surface facing out of the claw grip, such that a bicycle frame element being pushed into the claw grip will contact the slanted surface and press the catch downward against the biasing force until the frame element has passed the catch. The catch may be arranged such that it protrudes out from the first claw part on a side opposite the first bicycle abutment surface when the catch is in the retracted position. Alternatively, the first claw part may be designed such that it can accommodate the retracted catch inside the claw part.

The bicycle retaining device may comprise a locking arrangement for locking the second claw in one or more bicycle retaining positions in relation to the first claw part. Multiple retaining positions may be arranged stepwise or continuously in the longitudinal direction of the bicycle retaining device.

Although generally elongate and having a main extension in a longitudinal direction thereof, the supporting arm of the bicycle retaining device may have a shape which at least along a part thereof has a curved or bent shape. However, it may be preferred that at least an outer section of the support arm is straight, i.e. the section closest to the retaining claw.

The second claw part may be arranged to be movable by lateral translation in the longitudinal direction of the bicycle retaining device.

The second claw part may be arranged on an elongated sliding element, forming a shaft which may be arranged to be telescopically slidable inside a shaft portion of the bicycle retaining device such as inside the supporting arm. Such arrangement may be preferred when the second claw part is an outer claw part in the longitudinal direction of the bicycle retaining device.

Alternatively, the second claw part may be provided with an internal bore and may be slidably arranged on the outside of a shaft portion of the bicycle retaining device. Accordingly, the retaining claw may be opened and closed by sliding the second claw part along the shaft portion of the bicycle retaining device.

A further possibility is that the second claw part is arranged such that it can be rotated or tilted in relation to the first claw part, whereby the retaining claw is operated between an open and a closed position by rotating or tilting of the second claw part. One arrangement for opening and closing the retaining claw that may be used is that disclosed in WO 03/106221 A2. Accordingly, the supporting arm may be a tube or may comprise a tube section at an outer end of the supporting arm. The retaining claw may be arranged at the outer end of the supporting arm with the second claw part extending laterally from the end of a shaft which is slidably inserted into the supporting arm. The shaft may be arranged to be spring loaded inside the supporting arm, e.g. by means of a coil spring, which acts on a first end of the shaft and rests with a second end on a support located in the supporting arm tube such that the second claw part is spring biased towards the maximum open position of the retaining claw. The shaft may further be connected by means of a cable to a tightening device mounted on the outside of the supporting arm. Operation of the tightening device causes the cable to pull the second claw part in a direction towards the first claw part against the biasing force of the spring coil or other spring member acting on the shaft.

The disclosure also refers to a bicycle carrier arrangement for carrying a bicycle on a transporting vehicle, wherein the bicycle carrier arrangement comprises a bicycle retaining device as set out herein.

The bicycle carrier arrangement may comprise a support structure on which the bicycle retaining device is mounted. The support structure may be a roof rack or a support structure for mounting at the rear of a vehicle. The bicycle retaining device may be mounted on the support structure with the supporting arm pivotably attached at an inner end to the support structure or with the supporting arm attached in a fixed position to the support structure.

When loading a bicycle in the bicycle carrier arrangement, the bicycle is applied with a frame element inserted between the parts of the retaining claw. The catch of the bicycle retaining device acts against the gravitational force and prevents a bicycle loaded onto the bicycle carrier arrangement from falling out of the retaining claw in an initial loading phase before the retaining claw has been moved to a retaining position. Accordingly, a user can safely adjust the bicycle in the bicycle carrier arrangement and secure wheels and other parts of the bicycle as well as tighten the claw parts without at the same time having to hold the bicycle in place. This means that the user may freely tighten any straps, and other retaining elements as well as closing the retaining claw without risking that the bicycle falls out of the bicycle carrier arrangement.

The bicycle carrier arrangement as disclosed herein may be adapted for mounting on a vehicle roof or for mounting at a rear of a vehicle. When mounted on a vehicle roof, the bicycle retaining device may be mounted with the supporting arm pivotably attached to a support structure, such as a roof rack and extending at an angle from the support structure upwards from a vehicle roof. When loading the bicycle into the bicycle carrier arrangement a frame element such as a main frame element is inserted between the first and second parts of the retaining claw. In an arrangement of this type, the first, stationary claw part will be a lower claw part and the second, movable claw part, will be an upper claw part, as seen in the vertical direction. The bicycle is lifted into the bicycle carrier arrangement while the retaining claw is in an open position. Preferably, the first and second abutment surfaces are at the maximum distance from each other in order to obtain a maximum gap between the claw parts, thus facilitating insertion of the frame element in the retaining claw. Once having lifted the bicycle such that the frame element has passed the catch which protrudes upwardly from the first (lower) claw part, the bicycle may be lowered until the frame element comes to rest against the bicycle abutment surface on the first (lower) claw part. In this position, the catch prevents the bicycle from tilting to a side and falling sideways out of the retaining claw.

Depending on the design of the bicycle carrier arrangement, the bicycle carrier arrangement may be configured to be attached in different ways to the bicycle carrier arrangement. Accordingly the bicycle carrier arrangement may be configured such that the first bicycle abutment surface of the bicycle retaining device is arranged to abut a frame element of a standing bicycle from below. The bicycle retaining device may be arranged with the supporting arm at an angle to the horizontal plane, such at an angle of from 20° to 90°.

The bicycle carrier arrangement may be configured such that the first bicycle abutment surface of the bicycle retaining device is arranged to abut a frame element of a bicycle from above. This configuration may be useful in a bicycle carrier arrangement adapted for transporting a bicycle in a hanging position.

The bicycle carrier arrangement may be configured such that the first bicycle abutment surface of the bicycle retaining device is arranged to abut a frame element of a standing bicycle from a side. Such configuration may be used, e.g. to grip a seat post in order to prevent the bicycle from rolling or moving forward/rearward. Although a seat post is generally arranged to be removable from the bicycle, for the purpose of the bicycle carrier arrangement as disclosed herein, it is considered to be a “frame element” when mounted on the bicycle regardless of whether it is removable or is permanently attached to the other parts of the bicycle frame.

The second claw part may be arranged to be movable with respect to the supporting arm and the first claw part such that a distance between the first and the second bicycle abutment surfaces is adjustable between a maximum distance and a minimum distance.

The second claw part may be an upper claw part, and the first claw part may be a lower claw part. In this case it may be advantageous if the lower claw part comprises the catch. As mentioned, the second claw part, and thus the upper claw part, may be arranged to be movable with respect to the supporting arm and the first claw part such that a distance between the first and the second bicycle abutment surfaces is adjustable between a maximum distance and a minimum distance. This has been found to be advantageous as the bicycle will rest against the lower claw part, i.e. the shaft, abutment surface 6 or the inner wall of the catch, and the upper claw part is displaced to retain the bicycle. It permits a user to safely to secure wheels and other parts of the bicycle as well as tighten the claw parts without at the same time having to hold the bicycle in place. This means that the user may freely tighten any straps, and other retaining elements as well as close the retaining claw without risking that the bicycle moves out of the bicycle carrier arrangement by mistake. Further, when retaining the retaining claw, the upper claw part is the only claw part which is displaced. The position of the bicycle is thus not influenced as the upper claw part is displaced to a retaining position.

A second catch may be arranged at the outer end of the second claw part. Each of the first and the second claw parts may thus be arranged with a catch. The catches may be arranged to overlap each other when the first and the second clamping parts are closed, i.e. positioned to retain a bicycle.

The first catch of the first claw part may have a different length than the second catch of the second claw part. Preferably the first catch of the first claw part is longer than the second catch of the second claw part. Optionally the second catch of the second claw part is longer than the first catch of the first claw part. For example, the first claw part can be at least 1 cm, preferably at least 2 cm, longer than the second catch of the second claw part.

The retaining claw is preferably operated by an elongated element, preferably a flexible elongated element such as a wire. The elongated element can be winded about an axle, operable via a rotatable knob. The elongated element preferably extends from the second claw part, or upper claw part, along the support arm and preferably inside of the support arm, to the opposing end of the support arm. With a “standing bicycle”, as used herein, is implied a bicycle which is standing either on its wheels or upside-down.

It is also to be understood that the bicycle carrier arrangement as disclosed herein may be used to support and stabilize a bicycle which is standing up-side-down or a bicycle which is transported in a hanging position, e.g. by being hung on one or more hooks.

### BRIEF DESCRIPTION OF THE DRAWINGS

The present invention will be further explained hereinafter by means of non-limiting examples and with reference to the appended drawings wherein:

FIG. 1 shows a bicycle retaining device in a closed position;

FIG. 2 shows the bicycle retaining device in FIG. 1 in an open position and with a bicycle frame element being inserted into the bicycle retaining device;

FIG. 3 shows the bicycle retaining device in FIGS. 1 and 2 in an open position and with a bicycle frame element inserted into the bicycle retaining device;

FIG. 4 shows the bicycle retaining device in FIGS. 1-3 in a closed position with a bicycle frame element inserted into the bicycle retaining device;

FIG. 5 shows a bicycle mounted on a vehicle roof; and

FIG. 6 shows a bicycle mounted at the rear of a vehicle.

### DETAILED DESCRIPTION

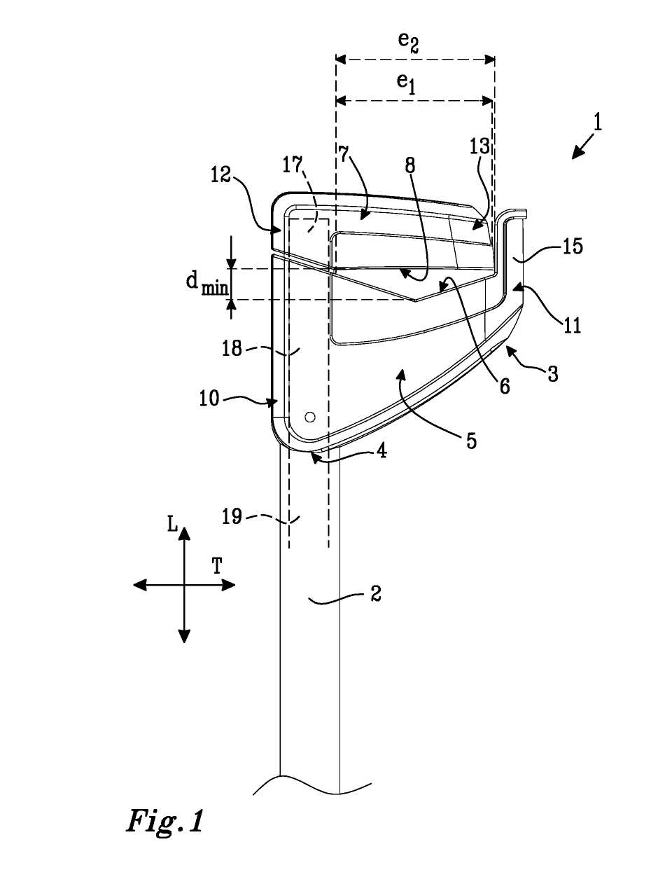

With reference to FIGS. 1-4 there is shown a bicycle retaining device 1 for retaining a bicycle in a bicycle carrier arrangement on a transporting vehicle. The bicycle retaining device 1 comprises a supporting arm 2 which extends in a longitudinal direction L of the retaining device. The retaining device 1 comprises a retaining claw 3 which is arranged at an outer end 4 of the supporting arm 2. The retaining claw 3 comprises a first claw part 5 comprising a first bicycle abutment surface 6. The first claw part 5 is rigidly joined to the supporting arm 2. The retaining claw 3 further comprises a second claw part 7 comprising a second bicycle abutment surface 8. The second claw part 7 is arranged with the second bicycle abutment surface 8 facing the first bicycle abutment surface 6, as shown in FIG. 1.

The abutment surfaces 8 are those surfaces of the retaining claw 3 which are intended to be in contact with a bicycle frame element when the bicycle retaining device is used for retaining a bicycle in a bicycle carrier arrangement on a transporting vehicle. Accordingly, the abutment surfaces are preferably made of a non-abrasive material and may be pressure resilient. Suitable materials for the abutment surfaces include plastics and natural and synthetic rubber materials. In FIG. 1 the first abutment surface 5 is shown with a V-shaped profile. It is to be understood that the first abutment surface 5 may have any other suitable profile, such as the straight profile shown for the second abutment surface 7 or a curved profile. Correspondingly, the second abutment surface may be configured differently from what is shown in FIGS. 1-4 and may have any suitable profile, including the profile shown for the first abutment surface 6 or a curved profile.

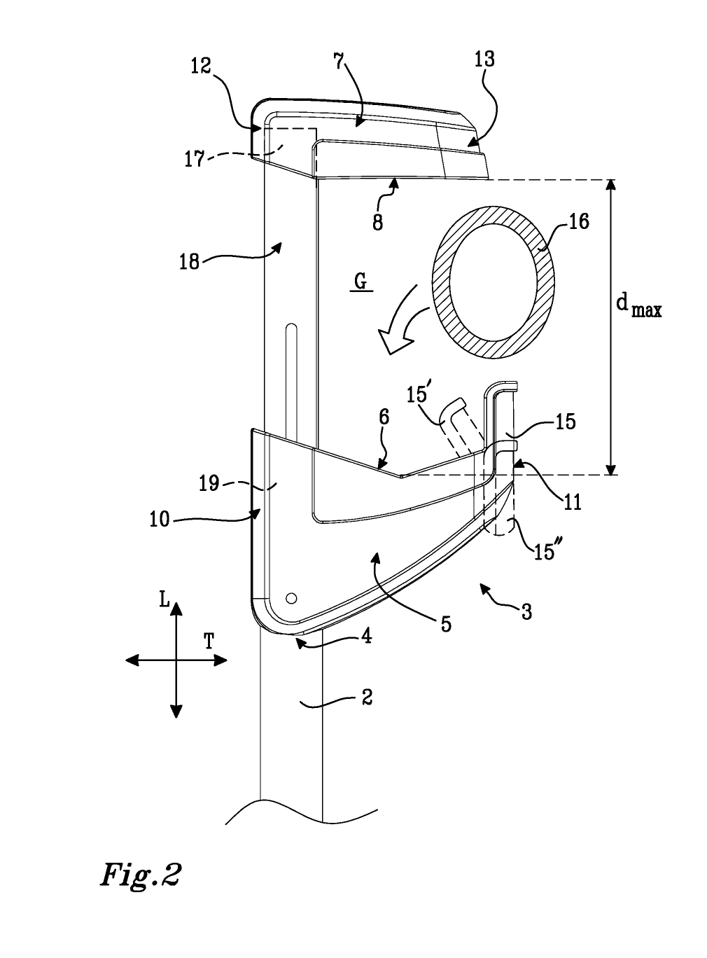

The second claw part 7 is arranged to be movable with respect to the supporting arm 2 and the first claw part 5 such that the distance, d, between the first and second bicycle abutment surfaces 6,8 is adjustable between a maximum distance dₘₐₓ as illustrated in FIG. 2 and a minimum distance dₘᵢₙ as illustrated in FIG. 1.

The first claw part 5 has an inner end 10 proximal to the supporting arm 2 and an outer end 11 distal from the supporting arm 2, and the second claw part 7 has an inner end 12 proximal to the supporting arm 2 and an outer end 13 distal from said supporting arm 2.

The bicycle retaining device 1 has a catch 15 which is arranged at the outer end 11 of the first claw part 5 and protruding from the outer end 11 of the first claw part 5 in a direction towards the second claw part 7. In the illustrated example, the catch 15 is shown to extend generally parallel with the longitudinal direction L of the supporting arm 2. In the shown embodiment, the catch 15 extends in the longitudinal direction L of the bicycle retaining device 1 outward of the outer end 13 of the second claw part 7. In other words, the extension e₁ of the second claw part 7 away from the supporting arm 2 in the lateral direction T of the retaining claw 3 is smaller than the distance between the supporting arm 2 and the catch 15 implying that the second claw part 7 can be fully accommodated inside the catch 15, as illustrated in FIG. 1.

In the illustrated embodiment, the first and second abutment surfaces 6,8 are shown to have the same lateral extension. However, this is not a necessary feature of the retaining device 1 as disclosed herein. By way of example, the upper/second claw part 7 and the second abutment surface 8 may have a smaller lateral extension than the lower/first claw part 5 and the first abutment surface 6. A design with a smaller upper/second claw part 7 may facilitate loading of a bicycle into the retaining device 1 as the opening into the gap G between the first and the second claw parts 5,7 is larger for the same distance of the claw parts 5,7 in the maximum open position of the retaining claw 3 than what is shown in FIG. 2.

In the embodiment in FIGS. 1-4, the catch 15 is shown to be fixedly arranged in a catching position in which the catch 15 extends from the outer end 11 of the first claw part 5 toward the outer end 13 of the second claw part 7. When the bicycle retaining device 1 is in a maximum open position, as shown in FIG. 2, the catch protrudes from the first claw part 5 into the gap G between the first and the second claw parts 5,7 and partially bridges the maximum distance dₘₐₓ between the first and said second abutment surfaces 6,8.

As an alternative to a fixedly arranged catch 15, the catch may be pivotably attached to the outer end 11 of the first claw part 5 and may be movable to an inwardly tilted position with the free end of the catch 15′ moved into the gap G between the first and the second claw parts 5,7, as indicated by dashed lines at 15′ in FIG. 2. Preferably, the catch 15′ is spring-biased toward the catching position, causing the catch 15′ to automatically return to the catching position as soon as the inwardly pushing force is removed. A further alternative arrangement of a non-rigidly attached catch is indicated at 15″ in FIG. 2. The catch 15″ is arranged to be movable out of the gap G between the first and the second claw parts 5,7 by pushing the catch 15″ downward. Preferably, the catch 15″ is spring-biased in the upward direction causing the catch 15″ to automatically return to the catching position as soon as the downwardly pushing force is removed. The terms 15 “inward”, “downward” and “upward” refer to the orientation of the bicycle retaining device 1 as shown in FIG. 2. The catch is preferably arranged to move out of the catching position when contacted by a frame element 16 of a bicycle being loaded into the bicycle retaining device 1. A hollow bicycle frame element 16 is shown in cross-section in FIGS. 2-4. As indicated in FIG. 2, the catch 15″ may be arranged to move downward such that it protrudes from the side of the first claw part 5 that is opposite to the first bicycle abutment surface 6. Alternatively, the first claw part 5 may be shaped such that it can accommodate the retracted catch 15″ in an internal passageway or cavity.

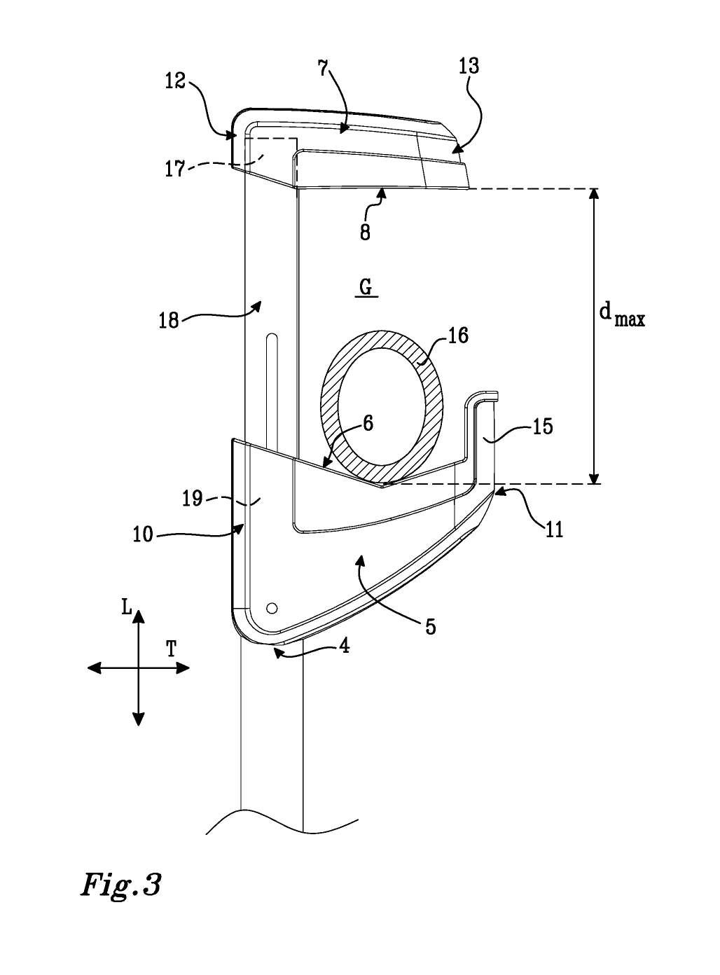

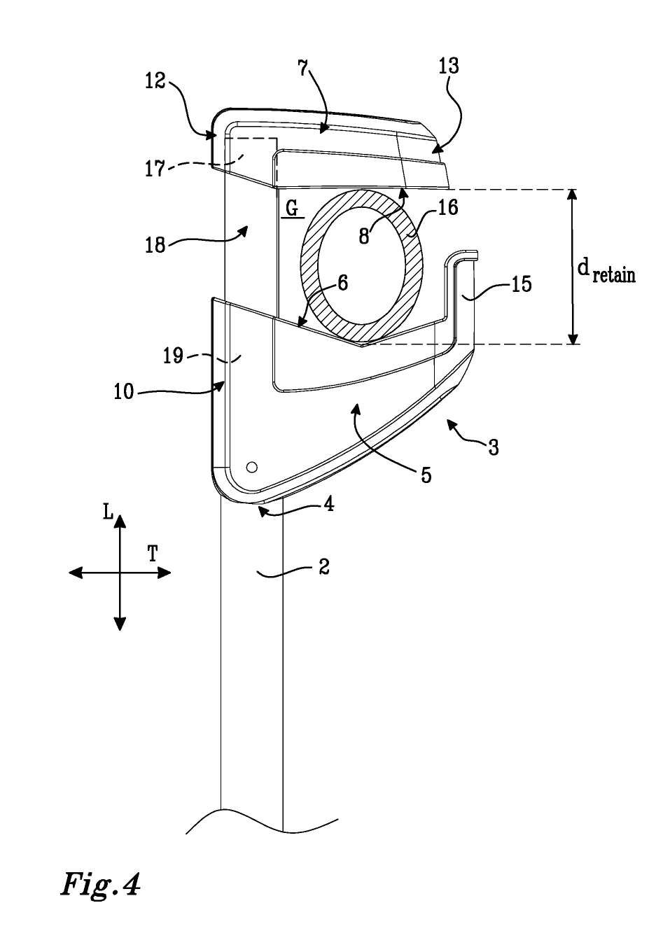

FIG. 2 illustrates a bicycle frame element 16 which is being inserted into the gap G between the first and the second claw parts 5,7 while the retaining claw 3 is in a maximum open position with the maximum distance dₘₐₓ between the first and said second abutment surfaces 6,8. The maximum distance dₘₐₓ is selected such that there is a sufficient distance between the catch 15 and the second claw part 7 to allow a bicycle frame element 16 to pass in between the first and the second claw parts 5,7. Preferably, the maximum distance dₘₐₓ is selected to allow the bicycle retaining device 1 to be used to retain frame elements 16 over a size range. In the maximum open position of the retaining claw 3, it can be seen that the second claw part 7 is attached at an outer end 17 of a shaft 18 which shaft 18 extends in the longitudinal direction L of the bicycle retaining device 1 and is inserted with an inner end 19 into a bore in the outer end 4 of the supporting arm 2. The shaft 18 is slidable arranged in a telescoping manner inside the supporting arm 2, and may be arranged to be operated between the open position shown in FIGS. 2 and 3 and a closed position as shown in FIGS. 1 and 4 by any suitable mechanism known to the person skilled in the art, such as the mechanism disclosed in WO 03/106221 A1 as set out herein.

In FIG. 3 is shown the bicycle frame element 16 fully inserted in the gap G between the first and the second claw parts 5,7 and resting against the first abutment surface 6. The retaining claw 3 is still in a maximum open position with the first and said second abutment surfaces 6,8 at their maximum mutual distance dₘᵢₙ. In the position shown in FIG. 3 the bicycle frame element 16 is hindered by the catch 15 from moving out of the retaining claw 3 unless the frame element 16 is first moved toward the second abutment surface 8, i.e. in the upward direction as shown in FIG. 3. When arranged e.g. as shown in FIG. 3 with the second claw part 7 as an upper claw part positioned above the first claw part 5 in a vertical direction, the catch 15 acts against gravity to hold the bicycle frame element 16 in the retaining claw 3 and to prevent the bicycle from falling out of the retaining claw 3.

Accordingly, a user can safely perform additional steps, such as adjusting the bicycle in a bicycle carrier arrangement and secure wheels and other parts of the bicycle as well as tighten the claw parts 5,7 without at the same time having to hold the bicycle in place. This means that the user may freely tighten any straps, and other retaining elements as well as close the retaining claw 3 without risking that the bicycle moves out of the bicycle carrier arrangement 1 by mistake.

FIG. 4 shows the bicycle retaining device 1 with the retaining claw 3 in a retaining position, i.e. with the second claw part 7 being moved to a position intermediate the maximum open position in FIGS. 2 and 3 and the completely closed position shown in FIG. 1. In the retaining position, the bicycle frame element 16 is clamped between the first and second abutment surfaces 6,8. The distance between the first and second bicycle abutment 30 surfaces 6,8 in this position is the bicycle retaining distance dᵣₑₜₐᵢₙ. The bicycle retaining distance dᵣₑₜₐᵢₙ is preferably variable in order to accommodate differently sized bicycle frame elements 16.

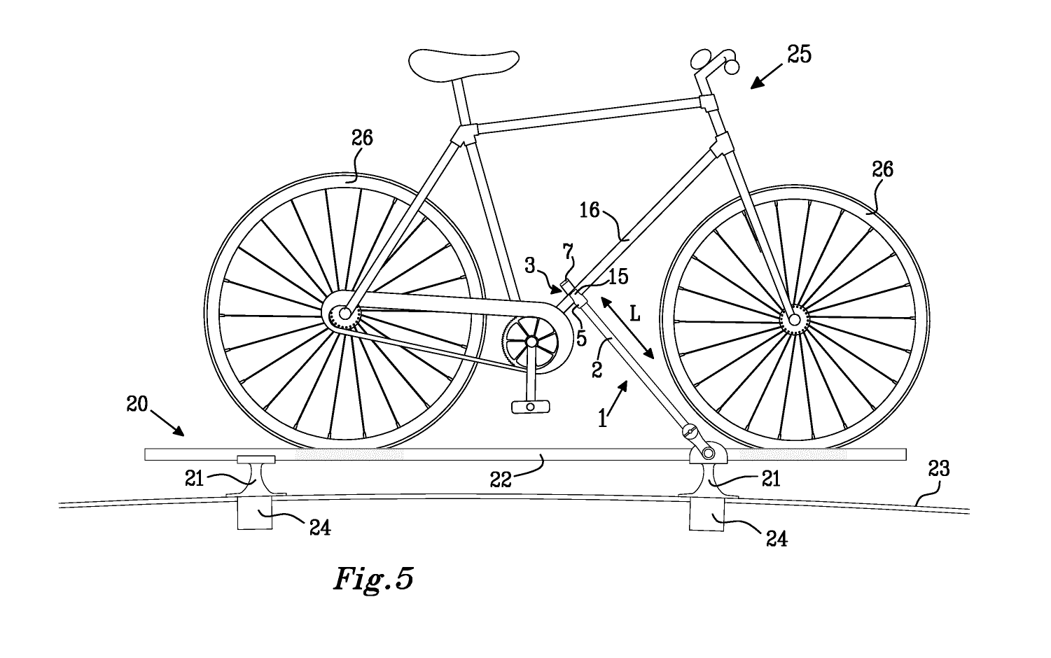

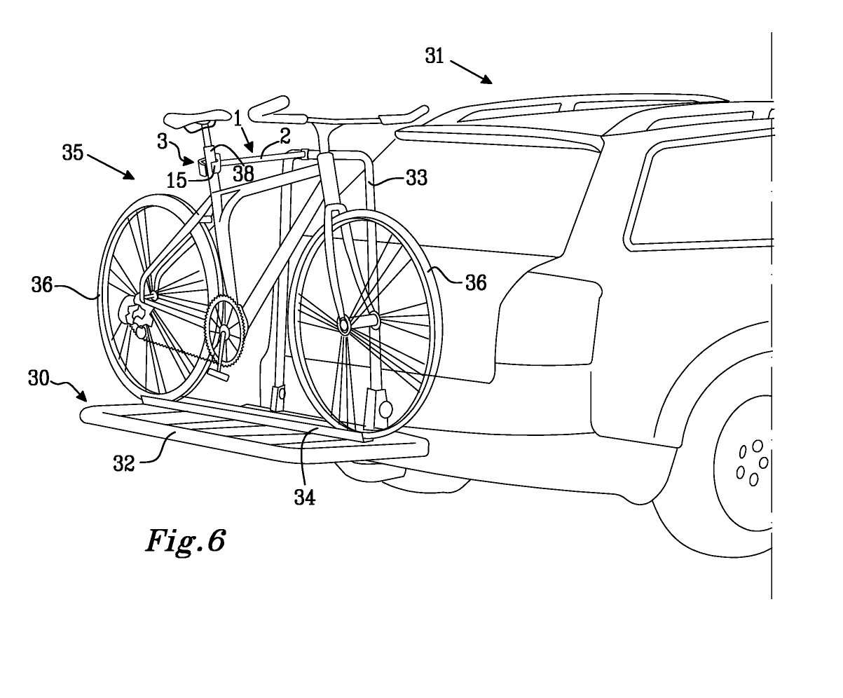

As shown in FIGS. 5 and 6, the bicycle retaining device 1 as disclosed herein may be used 35 in a bicycle carrier arrangement 20, 30. The embodiments shown in FIGS. 5 and 6 are intended as examples only and should not be considered limiting to the invention. It is to be understood that a bicycle carrier arrangement according to the invention could take any suitable form, as known in the art and could include fewer or more elements than the shown embodiments, such as supports, fastener devices, etc.

With reference to FIG. 5, the bicycle carrier arrangement 20 comprises a roof rack 21 onto which a bike rail 22 and a bicycle retaining device 1 are mounted. The roof rack 21 is mounted on a vehicle roof 23, such as a car roof by means of forward and rearward attachment devices 24. With “forward” as used in this context is implied a location on the vehicle which is forward in the normal travelling direction of the vehicle and “rearward” implies a location which is rearward as seen in the normal travelling direction of the vehicle. A bicycle retaining device 1 is shown to be attached at the forward attachment device 24. However, it is to be understood that the bicycle retaining device 1 may be attached at any suitable location or element in the bicycle carrier arrangement 20. The bicycle retaining device 1 is pivotably attached in the bicycle carrier arrangement 20 at the end 25 of the supporting arm 2 which is located opposite to the outer end 4 at which the retaining claw 3 is arranged. In this manner, the bicycle retaining device 1 can be tilted in a suitable angle such that the retaining claw 3 is properly positioned with respect to a bicycle frame element 16 which is applied in the retaining claw 3.

A bicycle 25 is shown loaded into the bicycle carrier arrangement 20 with the wheels 26 of the bicycle being supported by the bike rail 22. Although the bike rail 22 is shown in the figure with a straight profile, the bicycle retaining device 1 as disclosed herein may also be used with curved bike rails such as the bike rails disclosed in WO 03/106221 A1.

The bicycle carrier arrangement 20 is shown in FIG. 5 with the retaining claw 3 of the bicycle retaining device 1 in the maximum open position, which may also be referred to as the loading position. As can be seen in the figure, the catch 15 on the first claw part 5 of the retaining claw 3 blocks the passage out of the retaining claw 3 and prohibits the bicycle 25 from falling to the side, out of the retaining claw 3. Accordingly, the bicycle 25 remains standing on the bike rail 22 while the person loading the bicycle 25 onto the bicycle carrier arrangement 20 finishes the loading procedure by adjusting the bicycle position, and securing any fixation elements including closing the bicycle retaining device 1 on the bicycle frame element 16, as set out herein.

FIG. 6 shows a further embodiment of a bicycle carrier arrangement 30 which bicycle carrier arrangement 30 is attached at the rear of a vehicle, shown as a car 31. The bicycle carrier arrangement 30 comprises a horizontally arranged support frame 32 with a bike rail 34 supporting the wheels 36 of the bicycle 35 and a vertically arranged support frame 33 extending upward from the horizontally arranged support frame 32.

A bicycle retaining device 1 as disclosed herein is arranged at an upper part of the vertically arranged support frame 33 and extends rearwards in a generally horizontal direction from the vertically arranged support frame 33 and grips a bicycle frame element, which in this case is the seat post 38 of the bicycle 35. In the shown configuration, with the retaining claw 3 in the maximum open position, the catch 15 prevents the bicycle from moving forward, out of the retaining claw 3.

1.-17. (canceled)

18. A bicycle retaining device for retaining a bicycle in a bicycle carrier arrangement on a transporting vehicle, said bicycle retaining device comprising:
an elongated supporting arm extending in a longitudinal direction of said retaining device;
a retaining claw arranged at an outer end of said supporting arm, said retaining claw comprising:
a first claw part comprising a first bicycle abutment surface and being connected to said supporting arm, and
a second claw part comprising a second bicycle abutment surface, said second claw part being arranged with said second bicycle abutment surface facing said first bicycle abutment surface, said second claw part being arranged to be movable with respect to said supporting arm and said first claw part such that a distance between said first and said second bicycle abutment surfaces is adjustable between a maximum distance and a minimum distance,
wherein said first claw part has an inner end proximal to said supporting arm and an outer end distal from said supporting arm, and said second claw part has an inner end proximal to said supporting arm and an outer end distal from said supporting arm,
wherein a catch is arranged at said outer end of said first claw part, said catch having a catching position with said catch extending from said outer end of said first claw part in a direction toward said outer end of said second claw part, said catch being arranged to partially bridge said maximum distance between said first and said second abutment surfaces.

19. A bicycle retaining device in accordance with claim 18, wherein said second claw part is positioned outward of said first claw part at said outer end of said supporting arm, or wherein said second claw part is positioned inward of said first claw part at said outer end of said supporting arm.

20. A bicycle retaining device in accordance with claim 18, wherein said first claw part is rigidly joined to said supporting arm.

21. A bicycle retaining device in accordance with claim 18, wherein said catch in said catching position is arranged to bridge at least 25% of said maximum distance between said first and said second abutment surfaces, but not more than 55% of said maximum distance between said first and said second abutment surfaces.

22. A bicycle retaining device in accordance with claim 18, wherein a lateral extension of said first abutment surface away from said supporting aim is greater than a lateral extension of said second claw part away from said supporting arm, whereby said catch being arranged at said outer end of said first claw part is positioned laterally outward of said outer end of said second claw part in a lateral direction of said bicycle retaining device.

23. A bicycle retaining device in accordance with claim 18, wherein said catch is attached to said first claw part with a hinge and is foldable inward at said hinge towards said first bicycle abutment surface to assume a temporary loading position, wherein said catch is spring biased towards said catching position.

24. A bicycle retaining device in accordance with claim 18, wherein said catch is arranged to be movable out of a loading gap by pulling or pushing in said longitudinal direction of said bicycle retaining device, said catch being spring biased towards said catching position.

25. A bicycle retaining device in accordance with claim 18, wherein said bicycle retaining device comprises a locking arrangement for locking said second claw part in one or more bicycle clamping positions in relation to said first claw part.

26. A bicycle retaining device in accordance with claim 18, wherein said second claw part is arranged to be movable by lateral translation in said longitudinal direction of said bicycle retaining device.

27. A bicycle retaining device in accordance with claim 26, wherein said second claw part is arranged on an elongated sliding element, said elongated sliding element being arranged to be telescopically slidable inside said supporting arm.

28. A bicycle carrier arrangement for carrying a bicycle on a transporting vehicle, comprising:
a bicycle retaining device, comprising:
an elongated supporting arm extending in a longitudinal direction of said retaining device;
a retaining claw arranged at an outer end of said supporting arm, said retaining claw comprising:
a first claw part comprising a first bicycle abutment surface and being connected to said supporting arm, and
a second claw part comprising a second bicycle abutment surface, said second claw part being arranged with said second bicycle abutment surface facing said first bicycle abutment surface, said second claw part being arranged to be movable with respect to said supporting arm and said first claw part such that a distance between said first and said second bicycle abutment surfaces is adjustable between a maximum distance and a minimum distance,
wherein said first claw part has an inner end proximal to said supporting arm and an outer end distal from said supporting arm, and said second claw part has an inner end proximal to said supporting aim and an outer end distal from said supporting arm,
wherein a catch is arranged at said outer end of said first claw part, said catch having a catching position with said catch extending from said outer end of said first claw part in a direction toward said outer end of said second claw part, said catch being arranged to partially bridge said maximum distance between said first and said second abutment surfaces.

29. A bicycle carrier arrangement in accordance with claim 28, wherein said bicycle carrier arrangement is adapted for mounting on a vehicle roof

30. A bicycle carrier arrangement in accordance with claim 28, wherein said first bicycle abutment surface of said bicycle retaining device is arranged to abut a frame element of a standing bicycle from below.

31. A bicycle carrier arrangement in accordance with claim 28, wherein said first bicycle abutment surface of said bicycle retaining device is arranged to abut a frame element of a standing bicycle from a side of the frame element.
